(19) United States
(12) Patent Application Publication
(10) Pub. No.: US 2007/0162287 A1
(43) Pub. Date: Jul. 12, 2007

(54) Method and system for monitoring a packaging process or filling process

(75) Inventors: Claudius Dietzsch, Langnau am Albis (CH); Michael Eccarius, Linnich (DE)

Correspondence Address: THE WEBB LAW FIRM, P.C., 700 KOPPERS BUILDING, 436 SEVENTH AVENUE, PITTSBURGH, PA, 15219, US

(73) Assignee: SIG Technology Ltd., Neuhausen am Rheinfall (CH)

(21) Appl. No.: 10/554,428

(22) PCT Filed: Apr. 21, 2004
(86) PCT No.: PCT/EP04/04196

§ 371 Date: Oct. 12, 2006

(30) Foreign Application Priority Data
Apr. 25, 2003 (EP) 03405294.4

(51) Int. Cl. G06Q 99/00

(52) U.S. Cl. 705/1

(57) ABSTRACT

First and second items of data information are detected during a method for automatically monitoring a packaging or filling process of a packaging machine. The first items specify the packaging and/or a packaging material used for forming the packaging, and the second items serve to describe machine parts, or machine functions of the packaging machine and/or specify products that are used for producing the packaging in the packaging machine. Before a process step, a quality control is carried out by detecting first and second items of data information required for carrying out the quality control and by determining actual data based on these items of information. These actual data are compared with predetermined set data and when the set data and actual data correspond with one another within a range of tolerance, this process set is enabled.

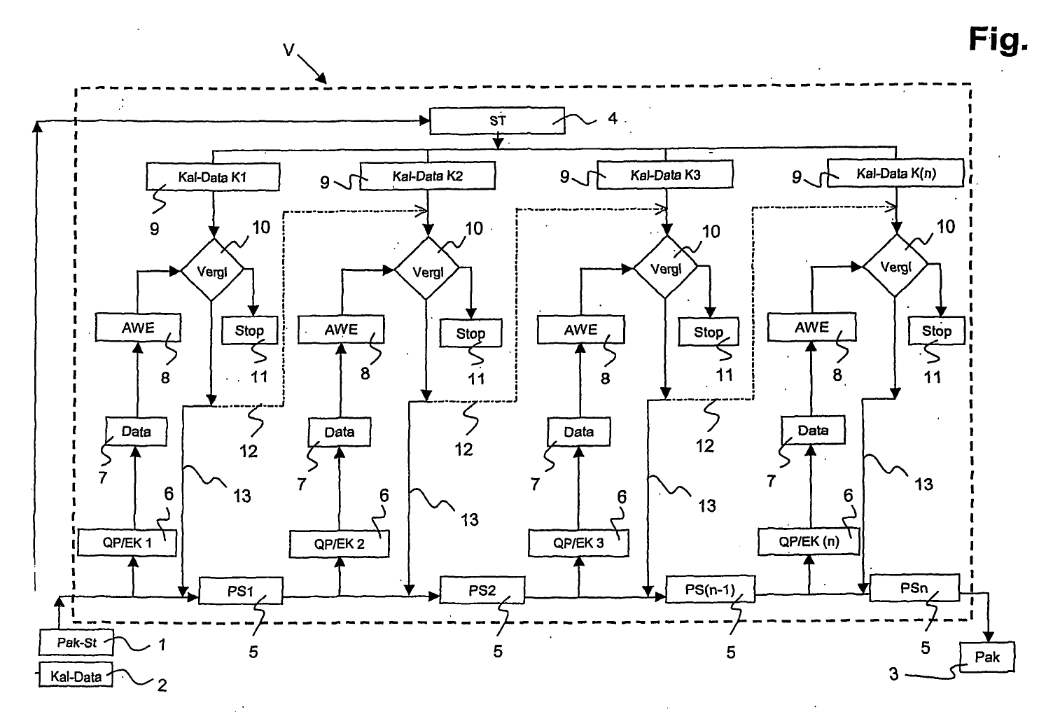

### TECHNICAL AREA

The present invention relates to a method and a system for monitoring a packing or filling procedure according to the preambles of Claim 1 and Claim 14, respectively.

### STATE OF THE ART

Greatly varying devices for packing piece goods or for filling liquid, granular, powdered, and/or solid products into portion packages are known in the related art. In this case, packing or filling devices are known which produce the packages to be filled from a raw material or a semifinished product before and/or during the filling. Furthermore, different monitoring systems are known in the related art which are to ensure the quality of the filled packages.

For example, EP-A-0 131 241 and EP-A-1 266 830 suggest identifying the packing material used in the packing machine automatically, so that the machine automatically selects the correct parameters for processing the packing material. EP-A-0 929 474 discloses a packing material which is provided with identification means of this type. US-A-2002/0104293 discloses a system which allows different products to be packed using the same machine, in that the individual products to be packed are automatically identified and the appropriate type of package is selected.

It has been recognized in DE-A-10 116 104 that these individual achievements of the object do not allow sufficient quality control. It was therefore suggested that data information from multiple surface checks of the packing material and weighing data be detected and processed uniformly. Defective, damaged, unfilled, or only partially filled packages may be recognized better in this way and eliminated from the running production process.

Furthermore, WO-A1-99/39817 discloses a method for the manufacture of biological chips, in which one sample is checked per production step and lot. If this sample does not meet the quality requirements, the entire lot is rejected.

A self-teaching system for manufacturing workpieces is described in U.S. Pat. No. 6,470,230. In this case, measured data of a manufactured workpiece is loaded into the machine controller to improve the quality of workpieces produced subsequently.

WO-A-03/017015 describes a method for characterising modules or modular units and a system for identification and/or for diagnosis of the module or modular unit which consists of a plurality of individual components. In this case, it is known per se that when individual components are exchanged, the data of the newly inserted components are transmitted to the data storage unit capable of being read and programmed. In this way, a simple identification of all individual components is ensured and a diagnosis function is also achieved with regard to monitoring over a certain operating cycle. However this only applies to the machine side and not to the products processed or treated by the machine.

U.S. Pat. No. 6,494,017 describes a generic method having the features of the preamble of claim 1. In this case, however the data information determined are not used for safety monitoring for providing guarantees.

### DESCRIPTION OF THE INVENTION

It is the object of the present invention to provide a method and a system which allow comprehensive quality control adopted to guaranteeing.

This object is achieved by a method and a system having the features of Claim 1 and Claim 14, respectively.

According to the present invention, not only the packing material and the package are monitored, but rather also machine parts, machine functions, and/or further products used in the manufacture of the package and/or in the filling process. In this way, comprehensive quality control is made possible, since the machine may be prevented from operating using incorrect parameters, the worn parts of the machine may be prevented from being replaced by cheap copies instead of original parts, and the use of cheap products instead of original additional products, such as an original adhesive, may be prevented.

Only the method according to the present invention allows for the manufacturer to perform a security check for guaranteeing. If original parts and products are not used exclusively and the machine is not operated in the mode suggested by the manufacturer, this is detected and noted in the system according to the present invention.

It is advantageous that the system may be constructed from identical modules, each module including a property class comprising selected data information. Depending on the desired quality control or packing machine to be monitored, the modules may be assembled into the desired system in a simple way. The system according to the present invention is therefore distinguished by a high degree of flexibility.

Further advantageous variations of the method and advantageous embodiments result from the dependent claims.

### BRIEF DESCRIPTION OF THE DRAWING

In the following, the object of the present invention is described on the basis of preferred exemplary embodiments which are explained on the basis of the attached drawing. The single FIGURE shows a flowchart of the system according to the present invention, installed in a packing machine.

### DETAILED DESCRIPTION OF THE EMBODIMENTS

In the FIGURE, a packing machine V is represented using dashed lines. A packing material 1 is supplied to this packing machine V. The packing material 1 may include already pre-manufactured, open packages. Typically, however, a packing material web from rolls or packing material blanks are used which are processed into packages and filled with products in the packing machine V. As noted at the beginning, the products may be piece goods or bulk goods in liquid, granular, powdered, and/or solid form.

The packing material 1 used is provided with calibration data 2. Depending on the type of the packing material 1 used, this data may be detected automatically using the system according to the present invention and transmitted to a control unit 4 of the packing machine V. However, it is also possible for this data to be input into the system through electronic transmission or by hand.

The packing material 1 passes through multiple process steps 5 in the packing machine V and leaves the machine as a filled, sealed package 3. The individual process steps 5 are identified in the FIGURE with PS1 through PSn.

The packing machine V is controlled via the control unit 4 in multiple sequential and/or parallel process steps 5 from the production of the package, via the introduction of the packed product, up to the sealing of the package. It is also possible that the packing machine does not seal the package itself, but rather this only occurs in a subsequent packing machine. The process steps 5 do not all have to relate to the processing of the packing material. They may also relate to preparation or filling of the packed product or a movement of a machine part, such as a cutter or a sealing jaw.

The packing material is monitored during its processing and the information obtained is registered as the first data information in the system, preferably in the central control unit 4. The calibration data 2 of the packing material 1 cited above is also a component of the first data information. According to the present invention, second data information is also collected, which specifies machine parts and machine functions of the packing machine as well as data on further products which are used during the manufacture of the package. Information on machine parts may be codes which are present on original parts and which must be replaced regularly as worn parts, for example. Worn parts of the packing machine of this type are sealing jaws, heaters, cutting blades, or filling heads, for example. Information on machine functions may be welding temperatures, welding times, pressures used, or advance speeds, for example. Further products may be adhesives which are used to glue the packing material, for example.

The data information from the group of the first and second data information is collected in the system into predetermined property classes. Which information is filed in which property classes is a function of the type of the packing machine V and the type of the desired quality control.

A quality check 6 is performed before at least one of the process steps 5. For this purpose, the data information of the associated property class is detected, for example, by checking a property of the packing material, the partially or completely manufactured package, or the adhesive used using suitable sensors. Depending on the type of the property to be checked, acoustic, optical, electrical, or magnetic sensors are suitable as sensors. Other properties, particularly machine parameters, may also be provided by the control unit 4. The different quality checks, which are each assigned to a property class, are identified in the FIGURE with QC/EK1 through QC/EK(n).

The registered data information of a quality check 5 is transmitted as data 7 to an analysis unit 8. In this analysis unit 8, the actual data which is based on the data information transmitted is established. This actual data is transmitted to a comparison unit 10 and compared to setpoint data 9, which is delivered by the system, preferably by the control unit 4, to the comparison unit 10. This setpoint data is shown in the FIGURE as calibration data for each property class and identified by Cal-Data K1 through K(n). If the comparison shows that the actual data corresponds to the setpoint data within a tolerance range, the next following process step is released, as may be recognized via the line 13 in the FIGURE. If the result is not within the tolerance range, the packing or filling procedure is preferably stopped automatically. This step is provided with the identification number 11 in the FIGURE. Instead of interrupting the procedure, it is also possible to generate an error message and still maintain the procedure for a predetermined period of time.

As is shown in the FIGURE using dashed lines 12, a result of a comparison may also be accepted in one of the following quality checks, preferably the next following quality check 6. This result is preferably processed with the setpoint data of the following property class and input into the comparison unit 10. This step may be repeated iteratively as long as there are property classes and quality check modules.

In the case of a packing machine whose final product is a sealed, filled package, in the first quality check, for example, the packing material blank may be checked before the erecting, for example, for its ability to be grooved, sealed, or folded. In a second check, the ready-to-fill package is checked before filling, for example, for its sterility. In a third check, the filled package and/or the adhesive used is checked before sealing and in a fourth check the sealed package is checked, for impermeability, for example. In this case, further checks may be interposed, for example, for the sealing temperature, the sealing jaws used, or the sealing time. The cutter used for producing the packing material blank may also be checked.

Preferably, only one physical property is taken into consideration in each property class. However, it is also possible to accommodate multiple different properties in the same property class. At least a part of the setpoint data is typically used for controlling the packing machine. The same analysis and comparison unit is preferably used for all quality checks, although it is shown multiple times in the FIGURE for better readability.

As may be recognized in the FIGURE, all quality checks run according to the same routine, independently of which data information is to be collected. The information contained in a property class may be processed according to predetermined rules to achieve a decision, i.e., whether the machine is to be stopped or operated further. This makes it easier to design the controller and the associated or integrated system. Thanks to its modular construction, the system may be installed easily in existing machines. Expansion or modification of the system is also simplified.

### LIST OF REFERENCE NUMBERS

1 packing material
2 calibration data
3 package
4 control unit
5 process step
6 quality check of a property class
7 detected data information
8 analysis unit
9 calibration data of a property class
10 comparison unit
11 interruption of the packing process
12 data transfer
13 release of the process step
V packing machine

1-16. (canceled)

17. A method for automatically monitoring a packing or filling procedure of a packing machine, comprising the steps of:
controlling the packing machine in multiple sequential or parallel process steps from the production of a package via introduction of a packaged good into the package up to the leaving of the filled package;
detecting first data information, wherein the first data information specifies the package or a packing material used to produce the package;
detecting second data information, wherein the second data information specifies machine parts or machine functions of the packing machine or products used for manufacturing the package in the packing machine;
utilizing the first and second data information to perform at least one quality check;
performing the quality check before at least one of the process steps, wherein the data information necessary for performing the quality check is detected and actual data based on this information is established;
comparing the actual data to predetermined setpoint data; and
releasing the corresponding process steps if the setpoint and the actual data correspond to a tolerance range, wherein the data information is used for performing a security check to identify use of unauthorized parts, products, or mode of operation, and wherein multiple quality checks are performed, whereby results of earlier performed quality checks are taken into consideration in at least some of the quality checks.

18. The method according to claim 17, wherein one of the stated quality checks is performed before multiple process steps, the quality check running according to a routine which remains the same.

19. The method according to claim 17, wherein one single physical property is checked per quality check.

20. The method according to claim 17, wherein the first and second data information is detected using acoustic, optical, electrical, or magnetic sensors.

21. The method according to claim 17, wherein in the event of insufficient correspondence of the setpoint and actual data, the packing machine is stopped automatically.

22. The method according to claim 17, wherein the actual data is determined in an analysis unit.

23. The method according to claim 22, wherein a shared analysis unit is used for all quality checks.

24. The method according to claim 17, wherein at least one packing material blank is subjected to a first quality check before erecting, wherein at least one finished package is subjected to a second quality check before filling, wherein at least one filed package is subjected to a third quality check before sealing, and wherein at least one sealed package is subjected to a fourth quality check.

25. The method according to claim 17, wherein an adhesive used to produce the package is detected to obtain the second data information.

26. The method according to claim 17, wherein sealing parameters are determined to obtain the second data information.

27. The method according to claim 17, wherein at least one of the ability of the packing material used to produce the package to be grooved, folded, or sealed is detected;
the sterility of the filled package is detected; and
the impermeability of the sealed package is detected.

28. The method according to claim 17, wherein data information from the group of the first and second data information is coordinated into property classes and one property class is checked in each quality check.

29. The method according to claim 28, wherein the information contained in the property class is processed according to predetermined rules to reach a decision.

30. A system for automatic monitoring of a packing or filling procedure of a packing machine, comprising:
a controller for controlling the packing machine in multiple sequential or parallel process steps from the production of a package via introduction of a packaged good into the package up to the leaving of the package;
first means for detecting first data information, wherein the first data information specifies the package or a packing material used to produce the package;
second means for detecting second data information, wherein the second data information specifies machine parts or machine functions of the packing machine or products used to manufacture the package in the packing machine;
at least one analysis and comparison unit for determining actual data based on the first and second data information, wherein the at least one analysis and comparison unit is configured to compare the actual data to predetermined setpoint data before a process step;
means for releasing the process step; and
means for detecting and storing information about the use of unauthorized parts or products.

31. The system according to claim 30, wherein the system includes multiple modules, wherein each module is used for performing a quality check before a process step, and the modules have an essentially identical structure.

32. The system according to claim 31, wherein the data information from the group of the first and second data information is coordinated into property classes and each module is assigned to a property class.
